(19) United States
(12) Patent Application Publication
(10) Pub. No.: US 2013/0086865 A1
(43) Pub. Date: Apr. 11, 2013

(54) WINDOW SEAL EXTRUDED WEATHER STRIP

(71) Applicants: James Schoonover, Shelby Township, MI (US); Vincent McNish, Fostoria, MI (US)

(72) Inventors: James Schoonover, Shelby Township, MI (US); Vincent McNish, Fostoria, MI (US)

(21) Appl. No.: 13/649,537

(22) Filed: Oct. 11, 2012

Related U.S. Application Data
(60) Provisional application No. 61/627,383, filed on Oct. 11, 2011.

(51) Int. Cl. B62D 65/08

(52) U.S. Cl. CPC B60J 10/0088
USPC 52/716.2

(57) ABSTRACT

The present invention is a weather strip having a body portion, and at least one elongated flange connected to the body portion. The elongated flange is operable with the body portion such that when the body portion is mounted in place in proximity to a wall member, the wall member applies a force to the elongated flange such that the elongated flange applies pressure to the wall member forming a seal between the elongated flange and the wall member. The weather strip of the present invention also includes at least one flexible member connected to the body portion, and the flexible member being is operable with the wall member such that the wall member applies a force to the flexible member and the at least one flexible member applies pressure to the wall member forming a seal between the at least one flexible member and the wall member.

### CROSS-REFERENCE TO RELATED APPLICATIONS

This application claims the benefit of U.S. Provisional Application No. 61/627,383, filed Oct. 11, 2011.

### FIELD OF THE INVENTION

The present invention is directed to a weather strip which is used for surrounding a window frame for providing a seal between the body panel of a vehicle and the window frame.

### BACKGROUND OF THE INVENTION

Weather strips are a common device used for the prevention of moisture and debris from entering a vehicle. Typically, all different types of vehicles have windows which allow the operator of the vehicle and the various passengers to be able to see out of the vehicle when inside. A weather strip is commonly used to surround the window, or surround the frame of a window in the case where a frame is also used, and provide a seal either between the window pane and the body panel of the vehicle, or between the frame and the body panel of the vehicle.

There are several kinds of weather strips which require the use of an additional seal which is applied after the weather strip is assembled to the vehicle. One commonly type of sealing material used is silicone. The silicone is applied between the weather strip and the body panel of the vehicle to ensure no moisture or debris leaks between the weather strip and body panel of the vehicle. This type of seal lacks the durability required for most applications because after being exposed to environmental conditions (rain, snow, ice, etc.) for a relatively short amount of time, the silicone will begin to leak.

Accordingly, there exists a need for an improved type of weather strip which eliminates the use of silicone, while still providing an adequate seal between the weather strip and the body panel of a vehicle.

### SUMMARY OF THE INVENTION

The present invention is a weather strip having a body portion, and at least one elongated flange connected to the body portion. The elongated flange is operable with the body portion such that when the body portion is mounted in place in proximity to a wall member, the wall member applies a force to the elongated flange such that the elongated flange applies pressure to the wall member forming a seal between the elongated flange and the wall member.

The weather strip of the present invention also includes at least one flexible member connected to the body portion, and the flexible member being is operable with the wall member such that the wall member applies a force to the flexible member and the at least one flexible member applies pressure to the wall member forming a seal between the at least one flexible member and the wall member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a weather strip, according to the present invention;

FIG. 2 is a side view of a weather strip, according to the present invention;

FIG. 3 is a sectional side view taken along lines 3-3 of FIG. 4, according to the present invention; and

FIG. 4 is a plan view of a weather strip mounted onto a frame, with the frame being mounted to the body panel of a vehicle.

### DETAILED DESCRIPTION OF THE PREFERRED EMBODIMENTS

The following description of the preferred embodiment(s) is merely exemplary in nature and is in no way intended to limit the invention, its application, or uses.

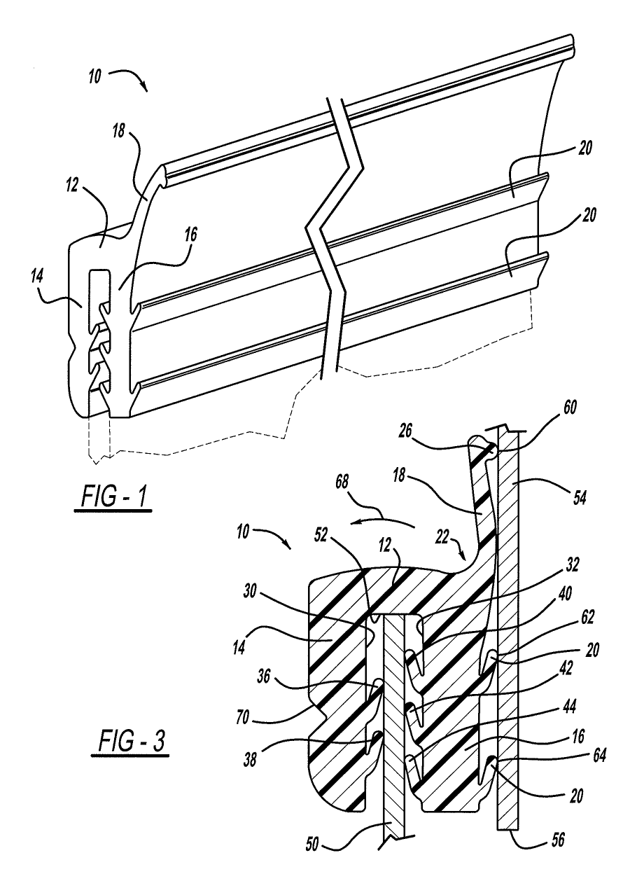

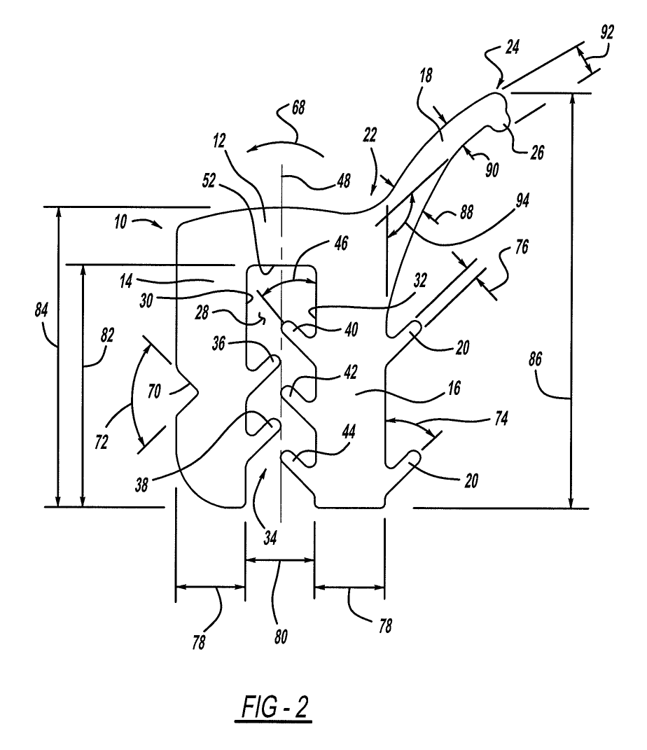

A weather strip according to the present invention is shown in the Figures generally at 10. The weather strip 10 includes a body portion 12 having two sides, a first side 14 and a second side 16. Attached to the second side 16 is an elongated flange 18, which is formed as part of the body portion 12. Also attached to the second side 16 of the body portion 12 is a pair of flexible members 20. While it is shown in FIGS. 1-3 that there are two flexible members 20, it is within the scope of the invention that more or less flexible members may be used.

While a first end 22 of the elongated flange 18 is connected to the body portion 12, a second end 24 of the elongated flange 18 includes a protrusion 26. The protrusion 26 is formed as part of the elongated flange 18.

As mentioned above, the body 12 has a first side 14 and a second side 16 which form a u shaped attachment portion for engaging an end flange 50 and attaching the weather strip 10 to the end flange. In between the first side 14 and the second side 16 is a recess 28. The recess 28 includes a first inner side 30 and a second inner side 32 Disposed in the recess 28 is a plurality of resilient flexible flanges, generally shown at 34, some of the flexible flanges 34 extend away from the first inner side 30 into the recess 28, and some of the flexible flanges 34 extend away from the second inner side 32 into the recess 28. In this embodiment, there are two flexible flanges 34 extending away from the first inner side 30, a first upper flexible flange 36, and a first lower flexible flange 38. There are also three flexible flanges 34 extending away from the second inner side 32, a second upper flexible flange 40, a middle flexible flange 42, and a second lower flexible flange 44. However, it is within the scope of the invention that more or less flexible flanges 34 may extend from either side 30,32 into the recess 28.

It can be seen in FIGS. 1-3 that the flanges 34 extending from the first inner side 30 are staggered with respect to the flanges 34 extending from the second inner side 32. The purpose of the flanges 34 being staggered is so that the flanges 34 may extend away from the sides 14,16 of the body portion 12 towards the middle of the recess 28 without interference with one another. By way of explanation without limitation, the flanges 34 extend away from the inner sides 30,32 at an angle 46, and terminate at a central axis 48. In this embodiment, the angle 46 is approximately forty-five degrees. Because the flanges 34 are staggered, fewer flanges 34 are required to support the weather strip on the end flange 50 of a window frame as an example; however, it is within the scope of the invention to use a greater or lesser number of flanges extending at different angles, depending upon the particular application and factors such as size, weight, length, material, and environment.

The end flange 50 is inserted into the recess 28, as the end flange 50 moves toward the bottom 52 of the recess 28, the flanges 34 flex and apply pressure to the end flange 50, maintaining the position of the end flange 50 in the recess 28. The staggered configuration of the flanges 34 also ensures that a uniform pressure is applied to the end flange 50.

Once the end flange 50 is received into the recess 28, the weather strip 10 may then be used to provide a sealing function for an outer panel, such as a wall member or an outer panel or body panel of a vehicle, such as a motor home. An example of a body panel of a vehicle incorporating the present invention is shown at 54.

The frame containing end flange 50 and weather strip 10 are assembled to the body panel 54 usually in relationship to an opening, such as an opening 56 of the body panel 54. While the opening 56 may generally be of any shape, in this embodiment the opening 56 is generally square shaped but includes curved portions, as described above. The opening 56 is typically used for supporting the frame including the end flange 50, and the frame having the end flange 50 is usually used for supporting a window pane 58. The frame 50 and weather strip 10 are arranged where the position of the elongated flange 18 is changed to what is shown in FIG. 3. In this configuration, the flexible members 20 are also moved to the position shown in FIG. 3. In this position, the protrusion 26 along with the flexible members 20 applies a force to the body panel 54. Because of the force applied by the protrusion 26 and the flexible members 20, a sealing function is provided by the weather strip 10 and the body panel 54, preventing moisture and debris from entering through the opening 56. There is a first seal 60 between the protrusion 26 and the body panel 54, a second seal 62 between one of the flexible members 20 and the body panel 54, and another seal 64 between the other of the flexible members 20 and the body panel 54. The protrusion 26 also functions to compensate for variations in the shape of the body panel 54.

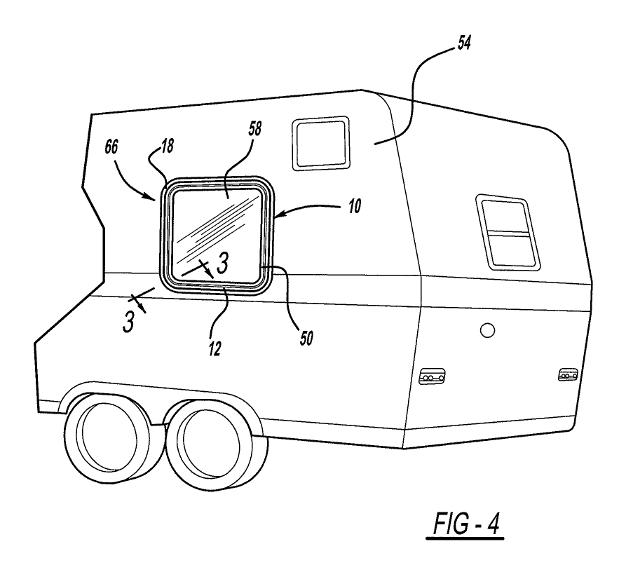

The bending of the elongated flange 18 to the position shown in FIG. 3 also serves the purpose of ensuring that the frame 50 remains positioned in the recess 28 in the areas where the frame 50 has a curvature, an example of which is shown generally at 66 in FIG. 4. The pressure applied to displace the elongated flange 18 generates a moment, in the general direction indicated by an arrow 68, about the body portion 12. The moment 68 generated causes rotational force in the general direction indicated by the arrow 68 to be applied to the first side 14, maintaining the position of the first side 14 relative to the frame 50, and maintain the flexible flanges 34 in contact with the frame 50, thereby preventing the weather strip 10 from becoming undesirably detached from the frame 50.

There is also a notch or groove 70 formed on the first side 14 of the body portion 12 for providing a streamlined and aesthetically pleasing appearance. The notch 70 is made of an angle 72 of substantially ninety degrees. The flexible members 20 extend from the body portion 12 at an angle 74 of approximately forty-five degrees. Also, the thickness 76 of the flexible members 20 and flexible flanges 34 is approximately 0.6 mm. The sides 14,16 of the body portion 12 also have a thickness 78 of approximately 3.0 millimeters. The distance 80 between the sides 14,16 of the body portion 12 (i.e. the width of the recess 28) is also approximately 3.0 mm. The height 82 of the recess 28 is approximately 10.5 mm, while the overall height 84 of the body portion 12 is approximately 13.0 mm, and the overall height 86 of the weather strip 10 (including the elongated flange 18) is approximately 17.9 mm. The elongated flange 18 also has a thickness 88 of 1.5 mm at the first end 22, which is larger than the thickness 90 of the rest of the elongated flange 18, which is approximately 1.2 mm. The thickness 92 of the elongated flange 18 where the protrusion 26 is located is approximately 1.6 mm. The elongated flange 18 extends away from the body portion 12 at an angle 94 of generally from about 110 to about 150 degrees angle typically from about 120 to about 145 degrees preferably about 130 to about 140 degrees with the most preferred angle of about one-hundred thirty-six degrees, but it is within the scope of the invention that a larger or smaller angle may be used provided that proper sealing to the between the protrusion 26 and the wall 56 is maintained. The material selected must be sufficiently resilient such that a proper biasing of the protrusion is provided for sealing against the wall or other member 56. Preferably, a vulcanized rubber polypropylene blend (TPV) material is used having a shore A durometer hardness of typically from about 65 to about 90 and preferably from about 80 to about 85. Materials useful in the present invention include thermoplastic vulcanisate (TVPs), polyvinyl chloride, thermoplastic polyolefins, and vulcanized rubber polypropylene blends or other extrudable elastomeric materials which can maintain a proper seal and are resilient for compressing against the wall or other member 56.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A weather strip, comprising:
a body portion;
at least one elongated flange connected to said body portion, said at least one elongated flange operable with said body portion such that when said body portion is mounted in place in proximity to a wall member, said wall member applies a force to said at least one elongated flange causing said at least one elongated flange to apply pressure to said wall member forming a seal between said at least one elongated flange and said wall member; and
at least one flexible member connected to said body portion, and said at least one flexible member being operable with said wall member such that said wall member applies a force to said at least one flexible member and said at least one flexible member applies pressure to said wall member forming a seal between said at least one flexible member and said wall member.

2. The weather strip of claim 1, said body portion further comprising:
a first side;
a second side operably connected to said first side;
a recess disposed between said first side and said second side; and
a frame member, said frame member operable for being received into said recess.

3. The weather strip of claim 2, wherein said at least one flexible member extends from said second side of said body portion such that said at least one flexible member receives pressure from said wall member, causing said at least one flexible member to flex and provide a sealing function between said at least one flexible member and said wall member.

4. The weather strip of claim 3, said frame member further comprising a curvature, wherein a moment is generated about said body portion as said wall member applies a force to said elongated flange, maintaining said at least one flexible member in contact with said frame member in the area in proximity to said curvature.

5. The weather strip of claim 2, further comprising:
a first inner side formed as part of said first side;
a second inner side formed as part of said second side;
one or more flexible flanges extending from said first inner side into said recess; and
one or more flexible flanges extending from said second inner side into said recess, wherein said one or more flexible flanges extending from said first inner side into said recess and said one or more flexible flanges extending from said second inner side into said recess flex and apply pressure to said frame member as said frame member is inserted into said recess.

6. The weather strip of claim 1, said elongated flange further comprising:
a first end connected to said body portion;
a second end formed on the opposite side of said elongated flange as said first end; and
a protrusion formed on said second end of said elongated flange, said protrusion contacting said wall member, causing said elongated flange to flex and said protrusion to apply force to said wall member, thereby creating said seal between said at least one elongated flange and said wall member.

7. The weather strip of claim 1, said wall member further comprising a body panel of a vehicle.

8. A weather strip, comprising:
a body portion having a first side and a second side;
a recess formed between said first side and said second side, said recess operable with a frame member for positioning said weather strip in proximity to a wall member;
an elongated flange extending from said body portion such that when said weather strip is placed in proximity to said wall member, said elongated flange flexes and applies pressure to said wall member to provide a sealing function between said elongated flange and said wall member; and
at least one flexible member formed as part of said body portion and extending away from said body portion on the same side of said body portion as said elongated flange, and when said weather strip is placed in proximity to said wall member said at least one flexible member flexes and applies pressure to said wall member to provide a sealing function between said at least one flexible member and said wall member.

9. The weather strip of claim 8, further comprising:
a first inner side formed as part of said first side;
a second inner side formed as part of said second side;
a plurality of flexible flanges extending from said first inner side of said body portion into said recess; and
a plurality of flexible flanges extending from said second inner side of said body portion into said recess such that said plurality of flexible flanges extending from said first inner side and said plurality of flexible flanges extending from said second inner side flexes and applies pressure to said frame member as said frame member is inserted into said recess.

10. The weather strip of claim 9, said frame member further comprising a curvature, wherein a moment is generated about said body portion as said wall member applies a force to said elongated flange, maintaining said plurality of flexible flanges in contact with said frame member in the area in proximity to said curvature.

11. The weather strip of claim 8, said elongated flange further comprising:
a first end connected to said body portion;
a second end formed on the opposite side of said elongated flange as said first end; and
a protrusion formed on said second end of said elongated flange, said protrusion contacting said wall member when said weather strip is placed in proximity to said wall member, causing said elongated flange to flex and said protrusion to apply force to said wall member, thereby providing said sealing function between said at least one elongated flange and said wall member.

12. The weather strip of claim 8, said wall member further comprising a body panel of a vehicle.

13. A weather strip for a vehicle, comprising:
a body portion having a first side and a second side;
a recess formed by said first side and said second side of said body portion, said recess operable for receiving a portion of a frame member;
an elongated flange extending from said second side of said body portion such that when said frame member is disposed in said recess and said weather strip is placed in proximity to a wall member, said elongated flange flexes and applies pressure to said wall member, providing a seal between said elongated flange and said wall member;
a first end formed on said elongated flange, said elongated flange connected to said body portion at said first end;
a second end formed on said elongated flange, said second end of said elongated flange having a protrusion selectively in contact with said wall member when said weather strip is placed in proximity with said wall member, said protrusion contacts said wall member, providing said seal between said elongated flange and said wall member;
at least one flexible member formed as part of said second side of said body portion, said at least one flexible member extending away from said second side of said body portion;
a first inner side formed as part of said first side;
a second inner side formed as part of said second side;
a plurality of flexible flanges extending from said first inner side of said body portion into said recess; and
a plurality of flexible flanges extending from said second inner side of said body portion into said recess such that said plurality of flexible flanges extending from said first inner side of said body portion and said plurality of flexible flanges extending from said second inner side of said body portion flexes and applies pressure to said frame member when said frame member is placed into said recess.

14. The weather strip of claim 13, said wall member further comprising a body panel of a vehicle.

15. The weather strip of claim 13, said frame member further comprising a curvature, wherein a moment is generated about said body portion as said wall member applies a force to said elongated flange, maintaining said at least one flexible flange in contact with said frame member in the area in proximity to said curvature.

16. An extruded belt weather strip for attaching to sealing between a surface including and end flange and vehicle surface which is substantially parallel with the end flange, said belt weather strip comprising:
a u shaped securement portion for engaging said end flange; and
a resilient elongated flange including a sealing surface which extends from said securement portion at an angle such that a resilient sealing pressure is generated during engagement with said substantially parallel vehicle surface.

17. The extruded belt weather strip of claim 16 wherein said resilient elongate flange is at and angle of from about 120 to about 145 degrees. The extruded belt weather strip of claim 16 wherein said resilient elongate flange is at an angle of from about 130 to about 140 degrees.

18. The extruded belt weather strip of claim 16 wherein said resilient elongate flange is at and angle of from about 110 to about 150 degrees.

19. The extruded belt weather strip of claim 16 wherein said resilient elongate flange is at and angle of about one hundred thirty six degrees.

20. The extruded belt weather strip of claim 16 wherein said resilient elongate flange is made from a thermoplastic olefin material having a durometer of from about 60 to about 95.

21. The extruded belt weather strip of claim 16 wherein said resilient elongate flange is made from a thermoplastic olefin material having a durometer of from about 80 to about 85.
